(19) United States
(12) Patent Application Publication
(10) Pub. No.: US 2018/0080279 A1
(43) Pub. Date: Mar. 22, 2018

(54) Multisectional Blind and Solar Collector Combination Device

(71) Applicant: Timothy Eubanks, SR., Carson, CA (US)

(72) Inventor: Timothy Eubanks, SR., Carson, CA (US)

(21) Appl. No.: 15/697,131

(22) Filed: Sep. 6, 2017

Related U.S. Application Data
(63) Continuation-in-part of application No. 14/874,003, filed on Oct. 2, 2015, now abandoned.

(51) Int. Cl. E06B 9/38; E06B 9/322; E06B 9/36; E06B 9/386; H02S 20/26

(52) U.S. Cl. CPC E06B 9/38; E06B 9/322; E06B 2009/2441; E06B 9/386; H02S 20/26; E06B 9/368

(57) ABSTRACT

A multisectional blind and solar collector combination device includes a plurality of parallel and vertically spaced housings. A back face of a primary one of the housings is a fixed solar panel. A power module is positioned in the primary housing and operationally coupled to the fixed solar panel. Each of a plurality of sections is coupled to a respective one of the housings and has a plurality of slats. Each housing holds a respective slat spacing motor and a respective slat rotation motor operationally coupled to the power module and the slats to adjust positioning and rotation of the slats within each section.

### CROSS-REFERENCE TO RELATED APPLICATIONS

This application is a continuation in part of application Ser. No. 14/874,003 filed Oct. 2, 2015.

### STATEMENT REGARDING FEDERALLY SPONSORED RESEARCH OR DEVELOPMENT

Not Applicable

### THE NAMES OF THE PARTIES TO A JOINT RESEARCH AGREEMENT

Not Applicable

### INCORPORATION-BY-REFERENCE OF MATERIAL SUBMITTED ON A COMPACT DISC OR AS A TEXT FILE VIA THE OFFICE ELECTRONIC FILING SYSTEM

Not Applicable

### STATEMENT REGARDING PRIOR DISCLOSURES BY THE INVENTOR OR JOINT INVENTOR

Not Applicable

### BACKGROUND OF THE INVENTION

### (1) Field of the Invention

### (2) Description of Related Art Including Information Disclosed Under 37 CFR 1.97 and 1.98

The disclosure and prior art relates to blind devices and more particularly pertains to a new blind device for self powering a multisectional blind.

### BRIEF SUMMARY OF THE INVENTION

An embodiment of the disclosure meets the needs presented above by generally comprising a plurality of parallel and vertically spaced housings. A back face of a primary one of the housings is a fixed solar panel. A power module is positioned in the primary housing and operationally coupled to the fixed solar panel. Each of a plurality of sections is coupled to a respective one of the housings and has a plurality of slats. Each housing holds a respective slat spacing motor and a respective slat rotation motor operationally coupled to the power module and the slats to adjust positioning and rotation of the slats within each section.

There has thus been outlined, rather broadly, the more important features of the disclosure in order that the detailed description thereof that follows may be better understood, and in order that the present contribution to the art may be better appreciated. There are additional features of the disclosure that will be described hereinafter and which will form the subject matter of the claims appended hereto.

The objects of the disclosure, along with the various features of novelty which characterize the disclosure, are pointed out with particularity in the claims annexed to and forming a part of this disclosure.

### BRIEF DESCRIPTION OF SEVERAL VIEWS OF THE DRAWING(S)

The disclosure will be better understood and objects other than those set forth above will become apparent when consideration is given to the following detailed description thereof. Such description makes reference to the annexed drawings wherein:

FIG. 1 is a front view of a multisectional blind and solar collector combination device according to an embodiment of the disclosure.

FIG. 2 is a side view of an embodiment of the disclosure.

FIG. 3 is a rear view of an embodiment of the disclosure.

FIG. 4 is a front view of a remote control of an embodiment of the disclosure.

FIG. 5 is a front view of a horizontal slat orientation embodiment of the disclosure.

FIG. 6 is a schematic view of an embodiment of the disclosure using a single power module.

FIG. 7 is a schematic view of an embodiment of the disclosure using multiple power modules.

### DETAILED DESCRIPTION OF THE INVENTION

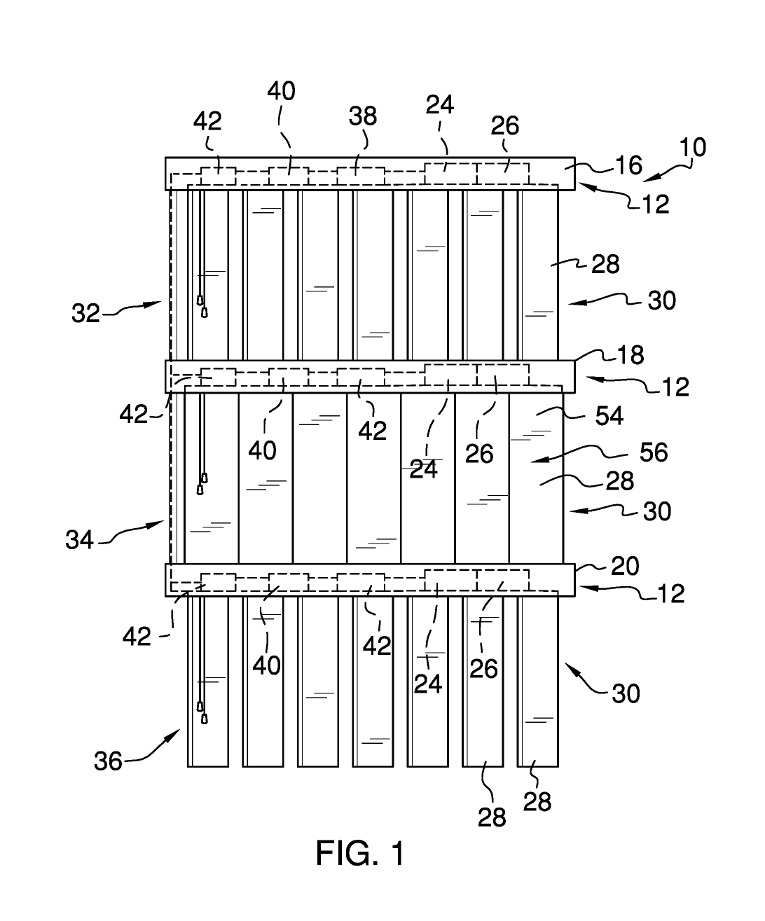

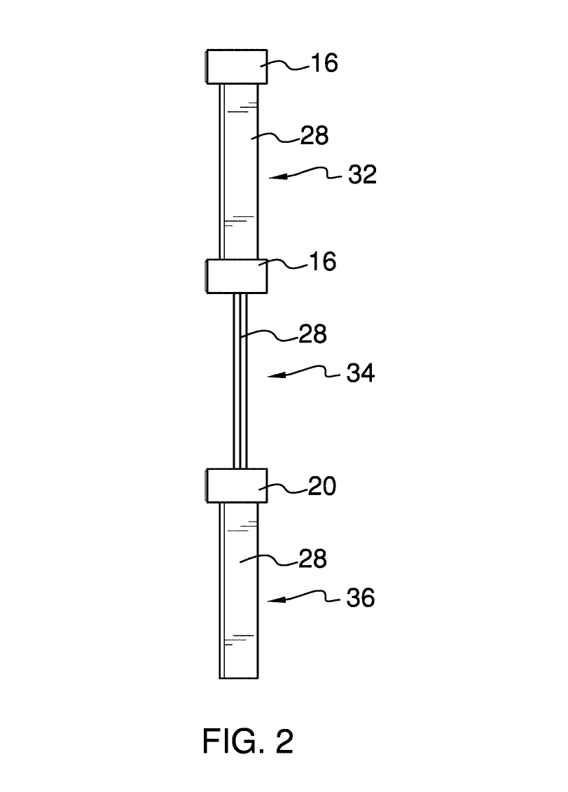

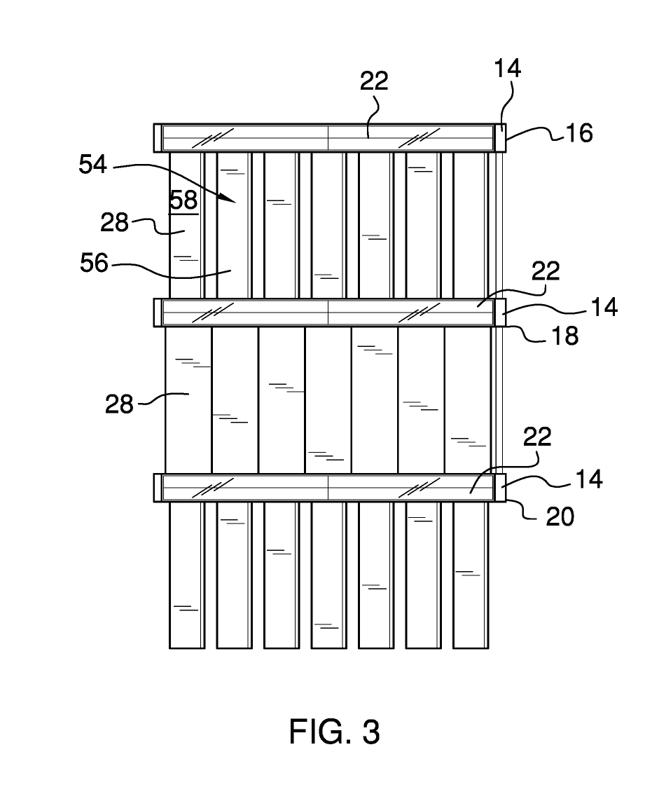

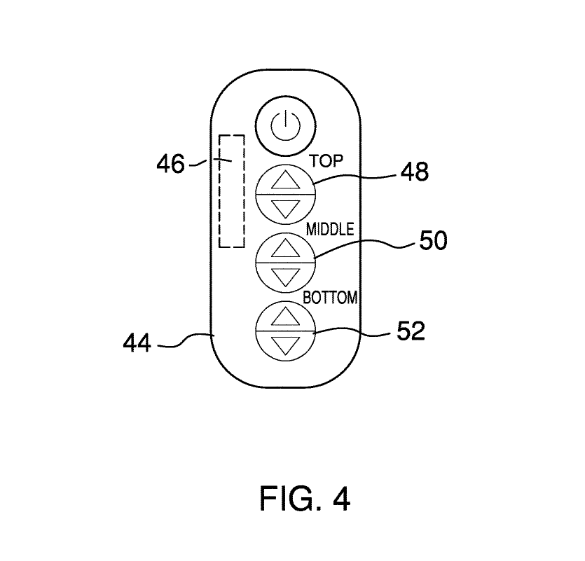

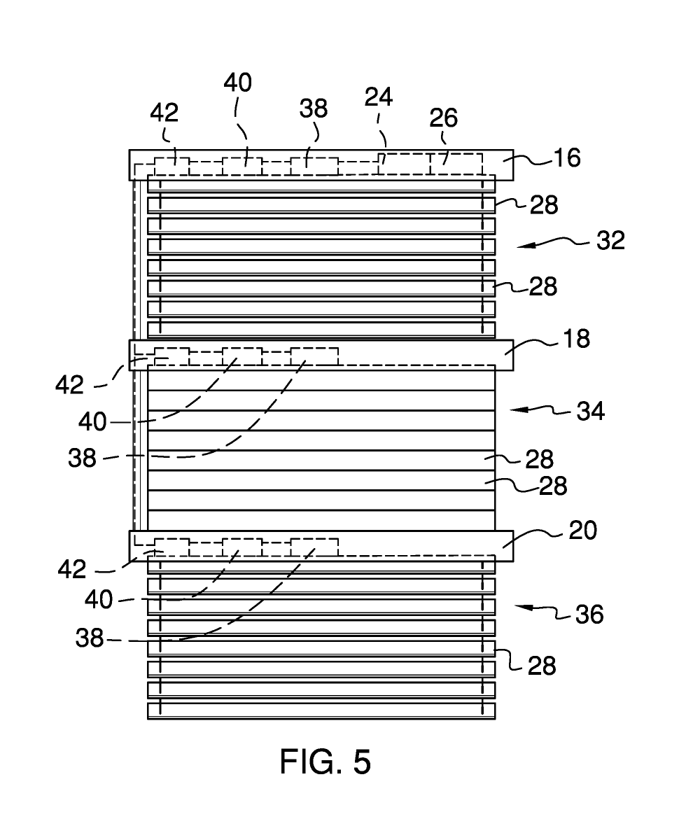

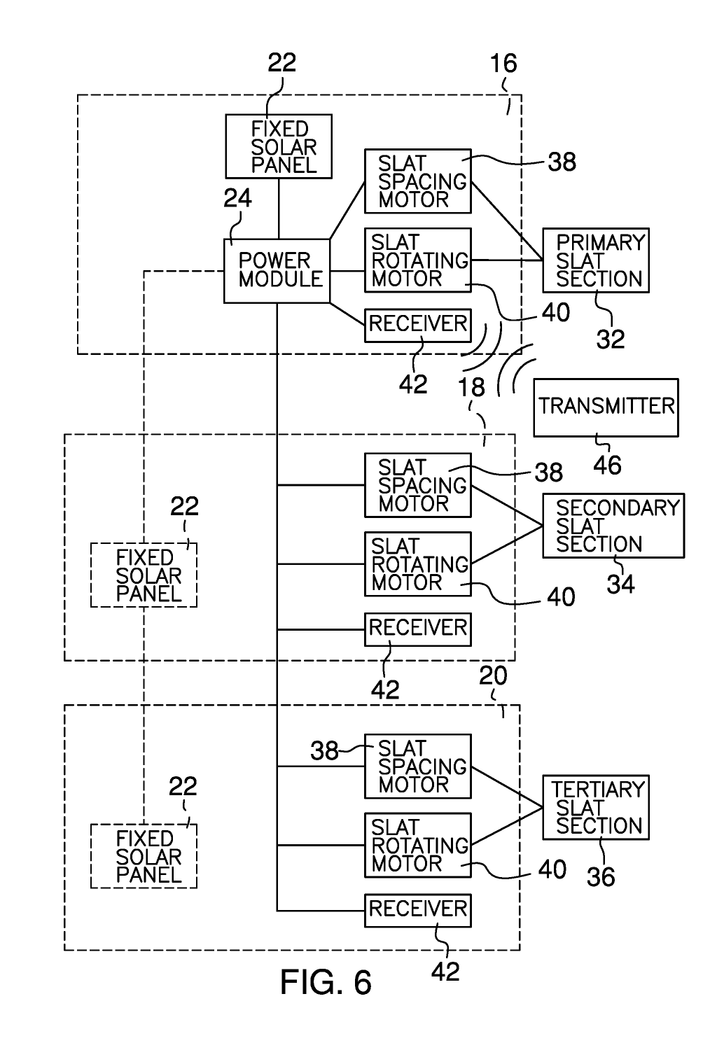

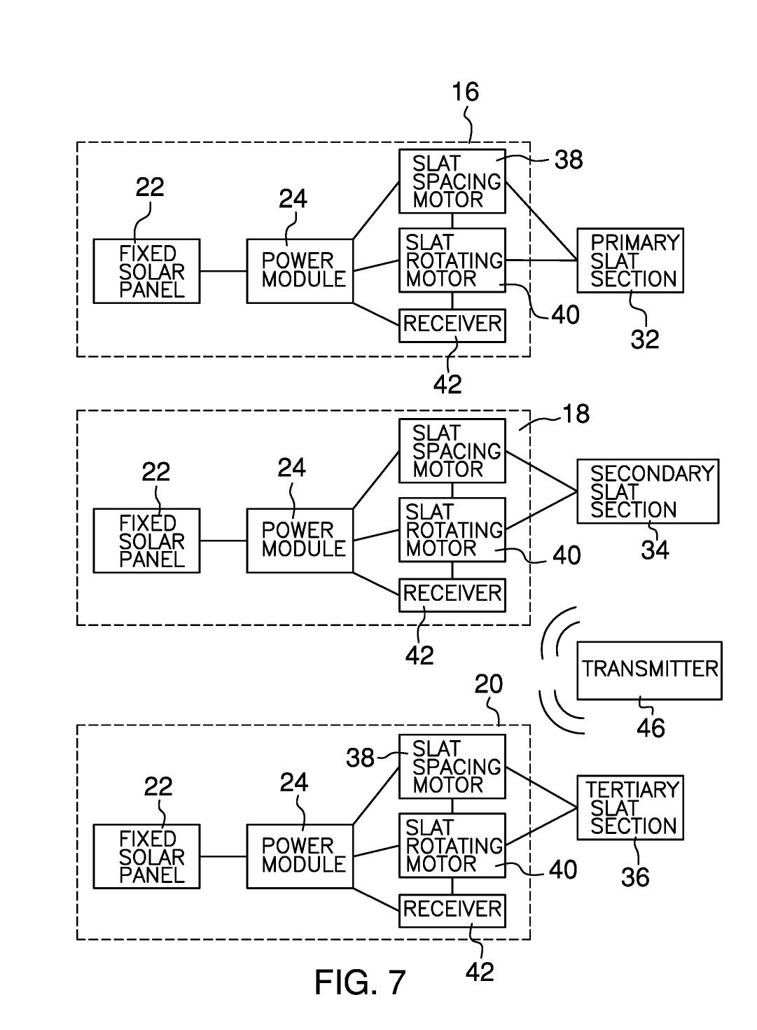

With reference now to the drawings, and in particular to FIGS. 1 through 7 thereof, a new blind device embodying the principles and concepts of an embodiment of the disclosure and generally designated by the reference numeral 10 will be described.

As best illustrated in FIGS. 1 through 7, the multisectional blind and solar collector combination device 10 generally comprises a plurality of housings 12. Each housing 12 has a back face 14. The housings 12 are parallel and vertically spaced apart. The plurality of housings 12 includes a primary housing 16, a secondary housing 18 and a tertiary housing 20. The secondary housing 18 is positioned vertically aligned below the primary housing 16 and the tertiary housing 20 is positioned vertically below the secondary housing 18. The back face 14 of the primary housing 16 is a fixed solar panel 22. Alternatively, independently or in combination, the back face 14 of each of the plurality of housings 12 may comprise a respective fixed solar panel 22. A power module 24 is coupled to and positioned in the primary housing 16 in a conventional manner. The power module 24 is operationally coupled to each fixed solar panel 22 by conventional wiring or the like. The power module 24 may include at least one rechargeable battery 26. The device 10 may also provide for independent or combinations of additional power modules 24 positioned in the secondary housing 18 and/or the tertiary housing 20. The power modules 24 may be connected in common or may be independent of each other.

Each of a plurality of slats 28 is positioned and arranged into a plurality of sections 30. The slats 28 of each section 30 is coupled to a respective one of the plurality of housings 12. The plurality of sections 30 includes a primary section 32 coupled to and extending from the primary housing 16, a secondary section 34 coupled to and extending from the secondary housing 18, and a tertiary section 36 coupled to and extending from the tertiary housing 20. Each of a plurality of slat spacing motors 38 is positioned in a respective one of the plurality of housings 12. Each slat spacing motor 38 is electrically coupled to the power module 24. The connection is a conventional electrical connection and may be to a single power module 24 or a respective one of multiple power modules 24 when each housing 12 has a respective power module 24. Each slat spacing motor 38 is operationally coupled to the slats 28 of a respective one of the sections 30 in a conventional manner whereby activation of the slat spacing motor 38 adjusts positioning between at least an adjacent pair of the slats 28 of the respective one of the sections 30 relative to the respective one of the housings 12. Similarly, each of a plurality of slat rotation motors 40 is positioned in a respective one of the plurality of housings 12. Each slat rotation motor 40 is electrically coupled to the power module 24. The connection is again of a conventional electrical nature and may be to a single power module 24 or a respective one of multiple power modules 24 when each housing 12 has a respective power module 24. Each slat rotation motor 40 is operationally coupled to the slats 28 of a respective one of the sections 30 in a conventional manner whereby activation of the slat rotation motor 40 adjusts an angle of each of the slats 28 of the respective one of the sections 30 relative to the respective one of the housings 12. Additionally, each slat spacing motor 38 and each slat rotation motor 40 may be provided for with redundant manual cord controls conventionally known for adjustment of blind slats.

A receiver 42 is coupled to at least one of the plurality of housings 12. The receiver 42 is operationally coupled to each of the plurality of slat spacing motors 38 and each of the slat rotation motors 40. Conventional wiring may be provided extending between the housings 12 to allow for use of a single receiver 42 or each housing 12 may be provided with an independent receiver 42. A remote control 44 has a wireless transmitter 46 in communication with the receiver 42 or each of the receivers 42 wherein manipulation of the remote control 44 allows for selective operation of each of the plurality of slat spacing motors 38 and the plurality of slat rotation motors 40 to adjust lateral positioning and rotation of the slats 28 of each of the sections 30. The device 10 is generally arranged for independent control of both positioning and rotation of the slats 28 within each section 30. The remote control 44 has a primary control 48 for the primary section 32, a secondary control 50 for the secondary section 34, and a tertiary control 52 for the tertiary section 36.

Additionally, each of the slats 28 may comprise a respective solar panel 54 electrically coupled to the power module 24 or an associated one of a plurality of power modules 24 in a conventional manner. Each of the slats 28 has respective photovoltaic modules 56 coupled to a back side 58 of the slats 28. Each of the photovoltaic modules 56 is operationally coupled to the power module 24 or the associated one of the power modules 24. As can be seen, each section 30 of slats 28 is controllable separately and may be independently powered. Additional sections 30 each extending from an associated housing 12 may be provided. The slats 28 may be provided in vertical or horizontal positions having conventional positional and rotation mechanisms operationally coupled to the slat spacing motors 38, slat rotation motors 40, and conventional adjustment cords.

In use, the device 10 is installed in a conventional manner typically adjacent to a window, door, or the like. The back face(s) 14 is faced outwardly to receive light for charging the power module(s) 24. When desired, each section 30 is independently controlled for adjusting position and rotation of the slats 28 within the particular section 30. The tiered arrangement of housings 12 and selectable slat orientation between embodiments provides for a customizable and controllable appearance to selectively let in or block exterior light.

With respect to the above description then, it is to be realized that the optimum dimensional relationships for the parts of an embodiment enabled by the disclosure, to include variations in size, materials, shape, form, function and manner of operation, assembly and use, are deemed readily apparent and obvious to one skilled in the art, and all equivalent relationships to those illustrated in the drawings and described in the specification are intended to be encompassed by an embodiment of the disclosure.

Therefore, the foregoing is considered as illustrative only of the principles of the disclosure. Further, since numerous modifications and changes will readily occur to those skilled in the art, it is not desired to limit the disclosure to the exact construction and operation shown and described, and accordingly, all suitable modifications and equivalents may be resorted to, falling within the scope of the disclosure. In this patent document, the word “comprising” is used in its non-limiting sense to mean that items following the word are included, but items not specifically mentioned are not excluded.

A reference to an element by the indefinite article “a” does not exclude the possibility that more than one of the element is present, unless the context clearly requires that there be only one of the elements.

I claim:

1. A multi-sectional blind and solar collector combination device comprising:
a plurality of housings, each said housing having a back face, said housings being parallel and vertically spaced apart, said plurality of housings including a primary housing, said back face of said primary housing comprising a fixed solar panel;
a power module, said power module being coupled to and positioned in said primary housing, said power module being operationally coupled to said fixed solar panel;
a plurality of slats, said slats being positioned in a plurality of sections, said slats of each said section being coupled to a respective one of said plurality of housings;
a plurality of slat spacing motors, each slat spacing motor being positioned in a respective one of said plurality of housings, each slat spacing motor being electrically coupled to said power module, each said slat spacing motor being operationally coupled to said slats of a respective one of said sections whereby activation of said slat spacing motor adjusts positioning between at least an adjacent pair of said slats of said respective one of said sections relative to said respective one of said housings; and
a plurality of slat rotation motors, each slat rotation motor being positioned in a respective one of said plurality of housings, each slat rotation motor being electrically coupled to said power module, each said slat rotation motor being operationally coupled to said slats of a respective one of said sections whereby activation of said slat rotation motor adjusts an angle of each of said slats of said respective one of said sections relative to said respective one of said housings.

2. The device of claim 1, further comprising:
said plurality of housings further including a secondary housing and a tertiary housing; and
said plurality of sections comprising a primary section coupled to and extending from said primary housing, a secondary section coupled to and extending from said secondary housing, and a tertiary section coupled to and extending from said tertiary housing.

3. The device of claim 2, further comprising said secondary housing being positioned vertically aligned below said primary housing and said tertiary housing being positioned vertically below said secondary housing.

4. The device of claim 1, further comprising:
a receiver coupled to one of said plurality of housings, said receiver being operationally coupled to each of said plurality of slat spacing motors and each of said slat rotation motors; and
a remote control, said remote control having a wireless transmitter in communication with said receiver wherein manipulation of said remote control selectively operates each of said plurality of slat spacing motors and said plurality of slat rotation motors to adjust lateral positioning and rotation of said slats of each of said sections.

5. The device of claim 4, further comprising:
said plurality of housings further including a secondary housing and a tertiary housing; and
said plurality of sections comprising a primary section coupled to and extending from said primary housing, a secondary section coupled to and extending from said secondary housing, and a tertiary section coupled to and extending from said tertiary housing.

6. The device of claim 5, further comprising said secondary housing being positioned vertically aligned below said primary housing and said tertiary housing being positioned vertically below said secondary housing.

7. The device of claim 5, further including said remote control having a primary control for primary section, a secondary control for said secondary section, and a tertiary control for said tertiary section.

8. The device of claim 1, further including said power module comprising at least one rechargeable battery.

9. The device of claim 1, further including each of said slats comprising a respective solar panel electrically coupled to said power module.

10. The device of claim 9, further including each of said slats having respective photovoltaic modules coupled to a back side of said slats, each of said photovoltaic modules being operationally coupled to said power module.

11. The device of claim 1, further including said slats being positioned horizontally.

12. The device of claim 1, further comprising said slats being positioned vertically.

13. A multi-sectional blind and solar collector combination device comprising:
a plurality of housings, each said housing having a back face, said housings being parallel and vertically spaced apart, said plurality of housings including a primary housing, said plurality of housings further including a secondary housing and a tertiary housing, said secondary housing being positioned vertically aligned below said primary housing and said tertiary housing being positioned vertically below said secondary housing, said back face of each of said plurality of housings comprising a respective fixed solar panel;
a power module, said power module being coupled to and positioned in said primary housing, said power module being operationally coupled to each said fixed solar panel, said power module comprising at least one rechargeable battery;
a plurality of slats, said slats being positioned in a plurality of sections, said slats of each said section being coupled to a respective one of said plurality of housings, said plurality of sections comprising a primary section coupled to and extending from said primary housing, a secondary section coupled to and extending from said secondary housing, and a tertiary section coupled to and extending from said tertiary housing;
a plurality of slat spacing motors, each slat spacing motor being positioned in a respective one of said plurality of housings, each slat spacing motor being electrically coupled to said power module, each said slat spacing motor being operationally coupled to said slats of a respective one of said sections whereby activation of said slat spacing motor adjusts positioning between at least an adjacent pair of said slats of said respective one of said sections relative to said respective one of said housings; and
a plurality of slat rotation motors, each slat rotation motor being positioned in a respective one of said plurality of housings, each slat rotation motor being electrically coupled to said power module, each said slat rotation motor being operationally coupled to said slats of a respective one of said sections whereby activation of said slat rotation motor adjusts an angle of each of said slats of said respective one of said sections relative to said respective one of said housings;
a receiver coupled to one of said plurality of housings, said receiver being operationally coupled to each of said plurality of slat spacing motors and each of said slat rotation motors;
a remote control, said remote control having a wireless transmitter in communication with said receiver wherein manipulation of said remote control selectively operates each of said plurality of slat spacing motors and said plurality of slat rotation motors to adjust lateral positioning and rotation of said slats of each of said sections, said remote control having a primary control for primary section, a secondary control for said secondary section, and a tertiary control for said tertiary section; and
each of said slats comprising a respective solar panel electrically coupled to said power module, each of said slats having respective photovoltaic modules coupled to a back side of said slats, each of said photovoltaic modules being operationally coupled to said power module.
